(19) United States
(12) Patent Application Publication
(10) Pub. No.: US 2006/0268916 A1
(43) Pub. Date: Nov. 30, 2006

(54) Reliable short messaging service

(76) Inventor: Susanta P. Sarkar, Rochester Hills, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/125,004

(22) Filed: May 9, 2005

(51) Int. Cl. H04L 12/28

(52) U.S. Cl. 370/431

(57) ABSTRACT

Methods and apparatus are provided for communicating messages between a message transmission architecture and a vehicle. The method comprises transmitting a short message service (SMS) message intended for a vehicle-based receiver and monitoring for an acknowledgement (ACK) message generated in response to the SMS message. The ACK message indicating receipt of the SMS message by the vehicle-based receiver. If there is no ACK message received within a timeout period, a circuit switched communication connection is initiated with the vehicle-based receiver.

### TECHNICAL FIELD

The present invention generally relates to a short message delivery system, and more particularly relates to a short message delivery system capable of using more than one communication method for message transmission to a vehicle-based wireless receiver.

### BACKGROUND OF THE INVENTION

Short Message Service (SMS) provides a mechanism for transmitting short messages to and from wireless devices. SMS is characterized by out-of-band packet delivery and low-bandwidth message transfer, which results in a highly efficient means for transmitting short bursts of data. Initial applications of SMS focused on eliminating alphanumeric pagers by permitting two-way general-purpose messaging and notification services, primarily for voice mail. As technology and networks evolved, a variety of services have been introduced, including e-mail, fax, and paging integration, interactive banking, information services such as stock quotes, and integration with Internet-based applications.

Once a message is sent, it is received by a Short Message Service Center (SMSC), which acts as a store-and-forward system for short messages. The SMSC provides the mechanisms required to find the wireless device(s) and transports short messages between the SMSCs and wireless devices. In contrast to other existing text-message transmission services such as alphanumeric paging, the service elements are designed to either deliver the short message or report that error when sent from a server connected to SMSC through wireline. Additionally, SMS supports several input mechanisms that allow interconnection with different message sources and destinations.

Because SMS uses a control or message channel (rather than a voice channel), a unique feature of SMS message is that the user can receive a SMS whether or not a call is in progress—the phone need only be turned on. If the phone is not turned on or the message is unable to go through, the message is stored in the SMSC until the destination device becomes available. Once the destination device is turned on or service is available, the message is sent. A “message received” is sent to the SMSC upon delivery to the wireless device, allowing the SMSC to provide confirmation of receipt to the sender.

Repeated retry is a method used to continually send a message until the message is received or a retry quota is exhausted. The store and forward approach is a variant of the retry method in which the message is stored in an intermediate location until it is delivered at the receipt end. These approaches are used to reliably deliver messages in an unreliable network.

Repeated retry on the same channel could be used, but this may have the undesirable effect of dealing with multiple copies of the same message at the receive end, time sensitivity of eventual receive, and termination of retries decision. The store and forward approach is used to make the retry termination decision, but it is less timely.

Accordingly, it is desirable to provide a reliable short message service that uses low cost short messages most of the time for a reliable transmission to a vehicle-based receiver and only uses the high cost circuit switched digital modem if short message transmission fails. Furthermore, other desirable features and characteristics of the present invention will become apparent from the subsequent detailed description and the appended claims, taken in conjunction with the accompanying drawings and the foregoing technical field and background.

### SUMMARY OF THE INVENTION

A method is provided for communicating messages between a message transmission architecture and a vehicle. The method comprises transmitting a short message service (SMS) message intended for a vehicle-based receiver and monitoring for an acknowledgement (ACK) message generated in response to the SMS message. The ACK message indicates receipt of the SMS message by the vehicle-based receiver. If there is no ACK message received within a timeout period, a circuit switched communication connection is initiated with the vehicle-based receiver.

### DESCRIPTION OF THE DRAWINGS

The present invention will hereinafter be described in conjunction with the following drawing figures, wherein like numerals denote like elements, and

FIG. 1 is a schematic representation of a communication system according to an example embodiment of the invention;

FIG. 2 is a block diagram illustrating one embodiment of a communication system for communicating a short message to a wireless communication node in a vehicle;

FIG. 3 is a message flow diagram showing a typical SMS message flow;

FIG. 4 is a message flow diagram showing an SMS message flow that utilizes two communications techniques;

FIG. 5 is a message flow diagram showing an example SMS message flow for an error condition; and

FIG. 6 is a flow diagram of a communication method according to an example embodiment of the invention.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various components, e.g., servers, modems, digital signal processing wired or wireless connections, or the like, which may carry out a variety of functions under the control of one or more microprocessors or other control devices. In addition, those skilled in the art will appreciate that the present invention may be practiced in conjunction with any number of practical vehicle computer system platforms, architectures, and deployments, and any number of practical communication system platforms, architectures, and deployments, and that the particular system described herein is merely one exemplary application for the invention.

For the sake of brevity, conventional techniques related to communication systems, wireless systems, vehicle systems and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

The following description may refer to components or features being “connected” or “coupled” together. As used herein, unless expressly stated otherwise, “connected” means that one component/feature is directly or indirectly connected to another component/feature, and not necessarily mechanically. Likewise, unless expressly stated otherwise, “coupled” means that one component/feature is directly or indirectly coupled to another component/feature, and not necessarily mechanically. Thus, although the schematic block diagrams depict example arrangements of elements, additional intervening elements, devices, features, or components may be present in an actual embodiment (assuming that the functionality of the systems or subsystems are not adversely affected).

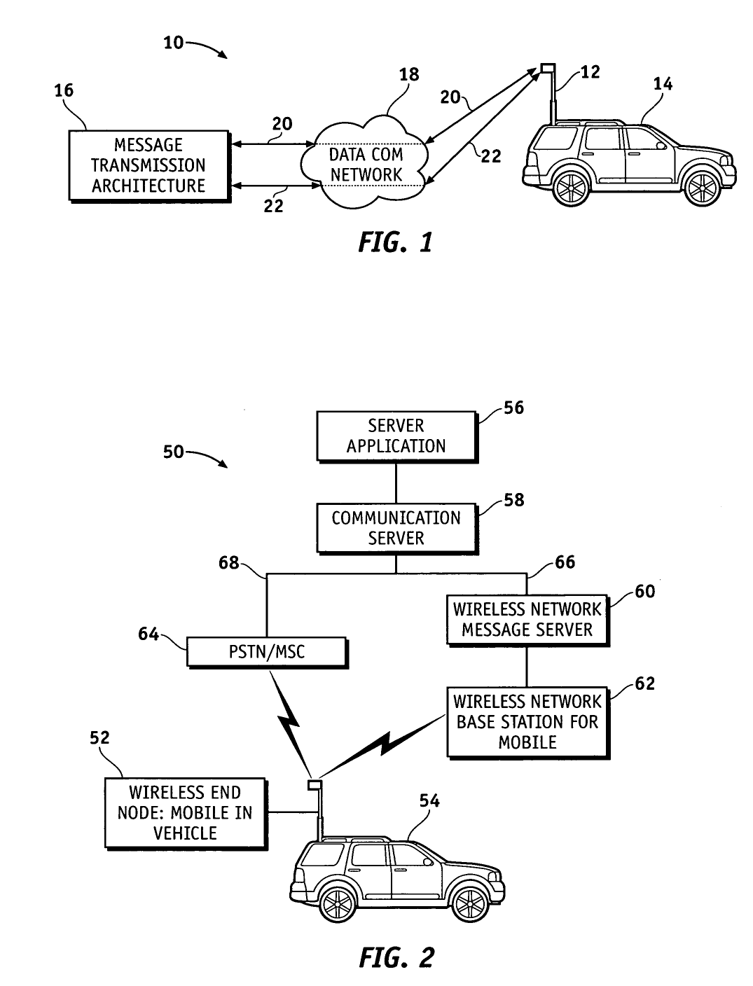

In FIGS. 1 and 2, the various system components may be implemented with physical hardware elements, virtual machines, and/or logical elements. Such system components may utilize general purpose microprocessors, controllers, or microcontrollers that are suitably configured to control the operation of the system described herein, or at least govern the processes described herein. In accordance with the practices of persons skilled in the art of communication, the present invention is described herein with reference to symbolic representations of operations that may be performed by various components within the system.

FIG. 1 is a schematic representation of a communication system 10 configured in accordance with an example embodiment of the invention for reliable delivery of short messages (SMS, text or binary) to and from a vehicle-based receiver or wireless communication node 12 present in a vehicle 14. System 10 generally includes message transmission architecture 16 coupled to a data communication network 18 that is configured to communicate with the vehicle 14. The message transmission architecture 16 may include one or more components for generating and sending the SMS message, such as a server application, a communications server, and a wireless network message server. The data communication network 18 provides two communication paths or channels 20, 22 over which the SMS message transmission architecture 16 may communicate with the vehicle 14. The first channel is a control or message channel 20, which may include a wireless network base station that is used for transmitting SMS messages to and from the wireless communication node 12 through the data communication network 18. The second channel is a voice channel 22, which may include a wireless operator connection server, which connects through the data communication network 18 to the wireless communication node 12. The proposed approach takes advantage of the existing alternate voice channel 22 to deliver a SMS message reliably in case of failure in the transmission of the message channel 20 in a timely manner. The message channel 20 is relatively inexpensive compared to the voice channel 22. In the context of this system, it is assumed that all remote communication to the vehicle is authenticated and some critical communication may be encrypted.

The system 10 is specially designed to take into account the following eventualities: the message channel 20 may not deliver each and every SMS message due to transmission error to or from the vehicle 14, or the wireless communication node 12 in the vehicle 14 may not be powered to receive transmission all the time. The system 10 provides the following advantages:
a. Communication cost is reduced as the system protocol uses the low cost message channel 20 most of the time for a reliable transaction, and only uses the high cost voice channel 22 if the SMS message transmission failed over the message channel 20.
b. Application software, running in the message transmission architecture 16 and a data communication network 18, can delegate sending of a SMS message over either channel and not deal with error conditions related to failed message transmission. This makes application software simpler.
c. SMS messages sent using the two channel method could be used for guaranteed delivery required by applications such as emergency alert, vehicle status query, etc.

Referring to FIG. 2, a block diagram illustrates one embodiment of a communication system 50 for communicating a SMS message to a vehicle-based receiver or wireless communication node 52 in a vehicle 54. System 50 utilizes a server application 56, a communication server 58, a wireless network message server 60, a wireless network base station 62 and a wireless operator's connection server 64. The servers can be web-enabled so that they are adapted to exchange information over not only the global Internet but as used in this specification “web-enabled” or “web-based” also means having the ability to exchange information over any network of interconnected computers in a known manner. Such exchange can be facilitated by the use of browsers, protocols and data formatting. One or more of the components of system 50 may include at least one software program for facilitating the communication and the exchange of information between them.

As discussed above in relation to FIG. 1, there are two paths that the server application 56 may communicate with the vehicle 54. The first path is a message channel 66, along the right side of FIG. 2, which is used for transmitting SMS messages to and from a wireless communication node 52. The second path is a voice channel 68, along the left side of FIG. 2, which connects through a digital modem coupled to the wireless communication node 52. The proposed approach takes advantage of the existing alternative voice channel 68 to deliver a SMS message reliably to the vehicle 54 in case of failure in the transmission through the message channel 66 in a timely manner. If needed, the voice channel 68 may establish a circuit switched communication connection and exchange data between the server application 56 and the wireless communication node 52. The message channel 66 is relatively inexpensive compared to the voice channel 68.

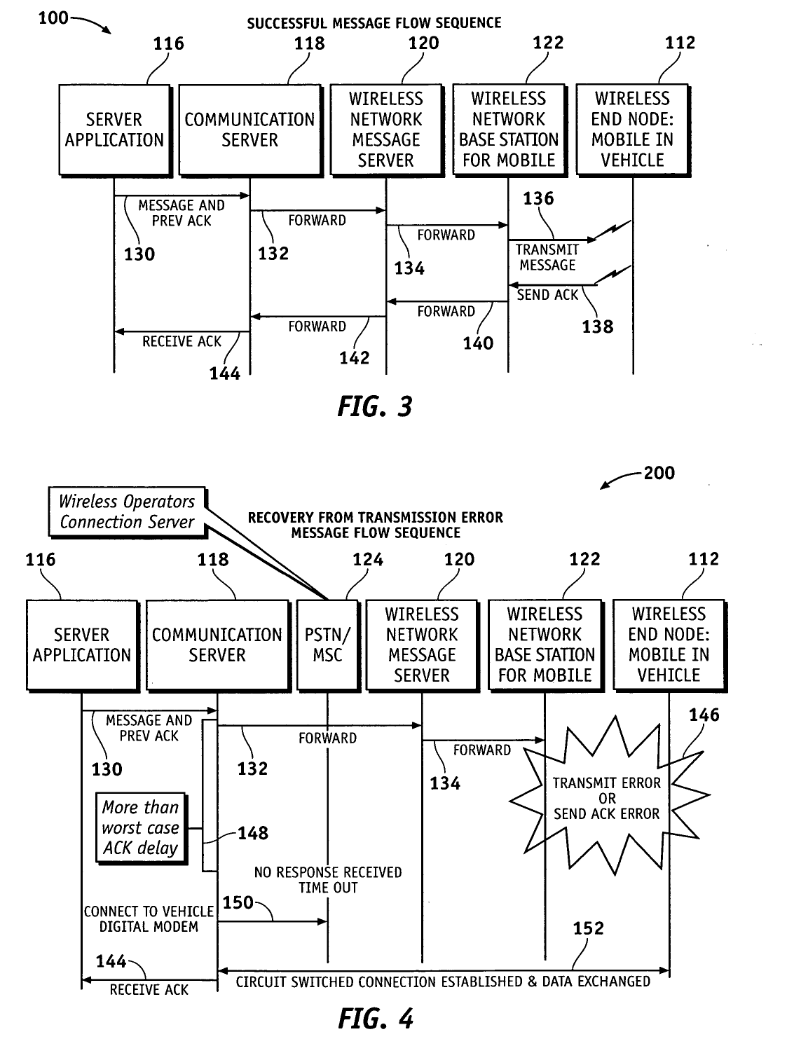

FIG. 3 is a message flow diagram showing one implementation of the architecture for a communication system 100 using a message path for transmitting a SMS message 130 from a server application 116 to a wireless communication node 112. The server application 116 sends the SMS message 130 intended for the vehicle-based receiver through a communication server 118, where the message is forwarded 132 to the wireless network message server 120 and forwarded 134 to the base station 122. The base station 122 then transmits the message wirelessly 136 to the wireless communication node 112 through wireless media. The server application 116 may use this method of communication to alert a vehicle occupant of emerging weather emergency or other timed sensitive alerts based on the occupant's profile in the server. It is expected that the physical connection from the server application 116 to the base station 122 is wire line based. In execution of this protocol, the SMS message 130 sent by the application server 116 may also contain the sequence number of a previous acknowledgement (ACK) or a receive ACK indicating receipt of a previous SMS message by the vehicle-based receiver, so that a record of what was received at the server application 116 can be reconciled at the sending end wireless communication node 112. In successful execution, upon receiving a successful transmit SMS message 136, the wireless communication node 112 in the vehicle 114 successfully sends back a receive ACK message 138 to the server application 116. The ACK message 138 is sent from the wireless communication node 112 wirelessly to the base station 122, where the ACK message is forwarded 140 from the base station 122 to the message server 120. The ACK message is then forwarded 142 through communication server 120. The receive ACK message 144 is then sent to the server application 116.

FIG. 4 is a message flow diagram showing a protocol that allows recovery from a transmission problem 146 between base station 122 and wireless communication node 112 identical to as shown in FIG. 3. In this embodiment, wireless communication node 112 is unable to either receive SMS message 136 from base station 122 or is unable to transmit the ACK message 138 back to the base station 122. If the communication server 116 does not receive any response within a timeout period 148, this indicates there may be a problem with the primary message channel, such as message channel 20 in FIG. 2. After the timeout period 148, the communication server 116 then tries to connect using an alternate channel, such as voice channel 22 of FIG. 2, by communicating with a wireless operator connection server 124 and requesting connection to the vehicle 150 using a digital modem. Wireless operator connection server 124 may be a Public Switched Telephone Network (PSTN) or a mobile switching center (MSC) that is capable of communicating with wireless communication node 112 over the alternate channel. If wireless communication node 112 is on, the alternate connection is established between communication sever 116 and wireless communication node 112 and data is exchanged over the circuit switched connection 152. The protocol also determines if the previously sent SMS message (transmit message 136) was received by wireless communication node 112. If the SMS message 136 was not received, the SMS message 130 is re-transmitted over the circuit switched connection 152. If the SMS message 136 was received but acknowledgement (send ACK 138) was not successfully transmitted, then acknowledgment is accepted over the circuit switched connection 152. This eventually leads to receive ACK 144 being sent from the communication server 118 to the server application 116.

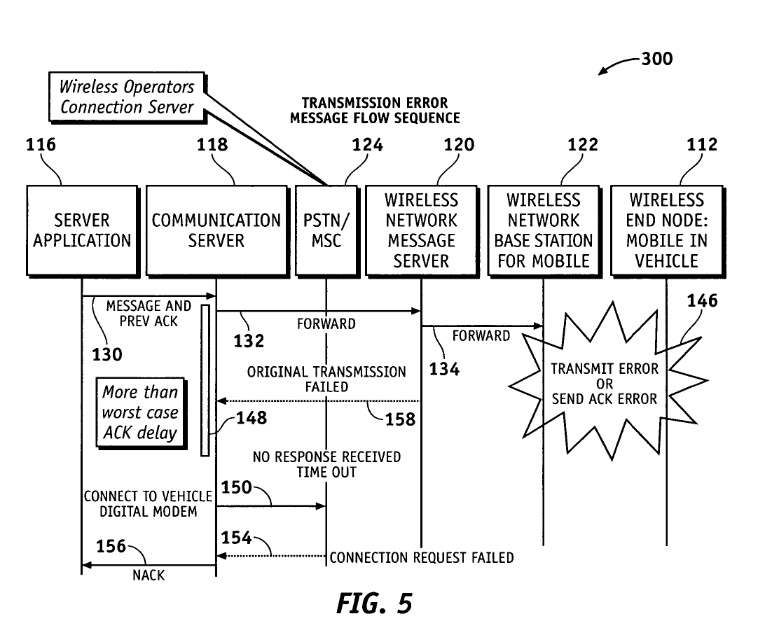

FIG. 5 is a message flow diagram showing a transmission problem 146 between base station 122 and wireless communication node 112 shown in FIG. 3. In this embodiment, wireless communication node 112 is unable to either receive transmission 136 from base station 122 or unable to transmit the ACK message 138 back to the base station 122. If the communication server 116 does not receive any response indicating receipt of the SMS message by the vehicle-based receiver within a timeout period 148, this indicates there may be a problem with the primary message channel, such as message channel 20 in FIG. 2. After the timeout period 148, the communication server 116 then tries to connect using an alternate channel, such as voice channel 22 of FIG. 2, by communicating with the wireless operator's connection server 124 and requesting connection to the vehicle 150 using a digital modem. In this case, connection 150 to the wireless communication node 112 failed 154, indicating probable un-powered state of the wireless communication node 112. Since it is unknown if the SMS message 130 was received by the wireless communication node 112, a non-acknowledgement (NACK) message 156 is generated and delivered from the communication server 118 to the server application 116. The wireless operator's server 120 system may also send a NACK message that the original transmission failed 158 to communication server 118 and occasionally to remind communication server 118 that the message did not go through. Receipt of a NACK message by the communication server 118 may prompt the communication server 118 to again request a circuit switch data connection 150 to the wireless communication node 112.

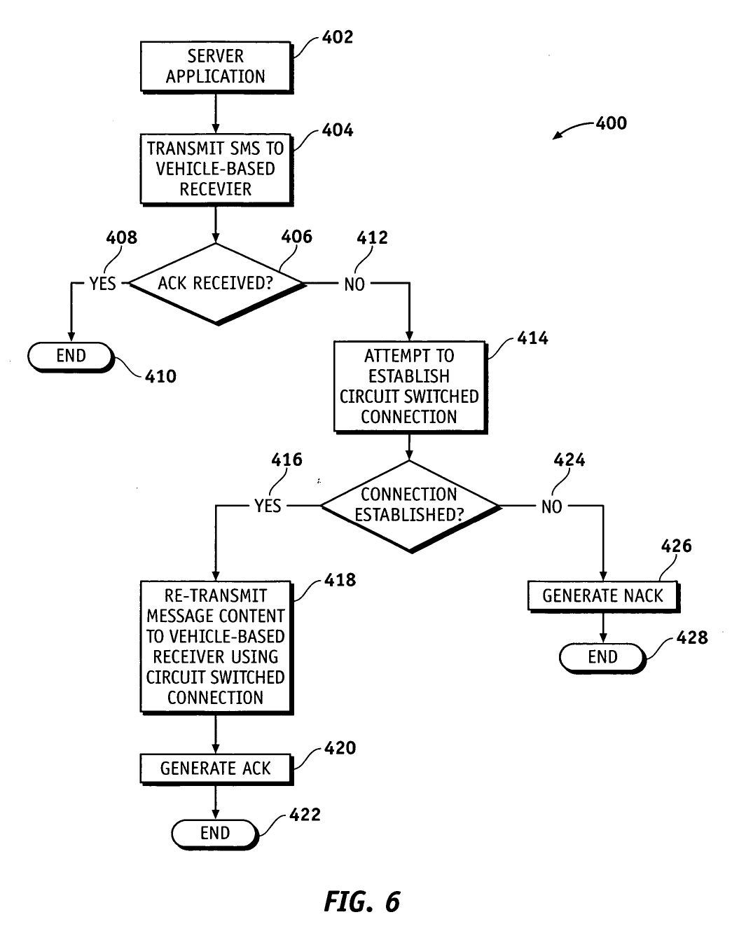

FIG. 6 is a flow diagram of a communication method 400 for communicating messages between a server application and a vehicle. The server application initiates a message (task 402) and transmits a short message service (SMS) message to a vehicle-based receiver, such as wireless communication node 112, via a message channel (task 404). The server application then monitors for an acknowledgement (ACK) message indicating receipt of the SMS message by the vehicle-based receiver within a timeout period (task 406). If there is an ACK message received (task 408) indicating successful delivery of the short message, no further communication between the devices is necessary (task 410). If there is no ACK message received within the timeout period (task 412), the server application attempts to establish a circuit switched communication connection with the vehicle-based receiver using an alternate voice channel (task 414). If the connection between the server application and the vehicle-based receiver is established (task 416), the server re-transmits the SMS message to the vehicle-based receiver using the circuit switched connection (task 418), an ACK is then generated and sent to the server application (task 420) and no further communication between the devices is necessary (task 422). If the server application is unable to connect with the vehicle-based receiver over the alternate voice channel (task 424), a no acknowledgement (NACK) message is then generated and sent to the server application (task 426) and no further communication between the devices is necessary (task 428). After the NACK is received, the server application may try again to establish a circuit switched communication connection with the vehicle-based receiver using the alternate voice channel.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for communicating messages between a message transmission architecture and a vehicle, the method comprising:
transmitting a short message service (SMS) message intended for a vehicle-based receiver;
monitoring for an acknowledgement (ACK) message generated in response to the SMS message, the ACK message indicating receipt of the SMS message by the vehicle based receiver; and
initiating a circuit switched communication connection with the vehicle-based receiver if no ACK message is received within a timeout period.

2. The method of claim 1, further comprising re-transmitting the SMS message over the circuit switched communication connection.

3. The method of claim 1, wherein transmitting a SMS message occurs over a message channel.

4. The method of claim 3, wherein the message channel is established at least in part by a wireless network base station coupled to the vehicle-based receiver.

5. The method of claim 4, wherein the SMS message is transmitted from the wireless network base station to the vehicle-based receiver, and an ACK message from the vehicle-based receiver is received by the wireless network base station.

6. The method of claim 1, further comprising establishing the circuit switched communication connection over a voice channel.

7. The method of claim 6, wherein the voice channel is established at least in part by a wireless operator connection server coupled to the vehicle-based receiver.

8. The method of claim 7, wherein the SMS message is transmitted from the wireless operator connection server to the vehicle-based receiver, and an ACK message from the vehicle-based receiver is received by the wireless operator connection server.

9. The method of claim 1, wherein initiating a circuit switched communication connection comprises establishing a digital modem channel between the message transmission architecture and the vehicle-based receiver.

10. The method of claim 1, further comprising receiving a NACK if the circuit switched connection fails to connect with the vehicle-based receiver.

11. The method of claim 10, further comprising initiating a circuit switched communication connection with the vehicle-based receiver in response to a NACK.

12. A method for providing short message service (SMS) between a message transmission architecture and a vehicle, the method comprising:
transmitting a SMS message over a message channel, the SMS message being intended for a vehicle-based receiver;
if no acknowledgement (ACK) message identifying receipt of the SMS message by the vehicle-based receiver is received within a timeout period, establishing a voice channel between the message transmission architecture and the vehicle-based receiver; and
re-transmitting the SMS message over the voice channel.

13. The method of claim 12, wherein the voice channel is a circuit switched communication connection.

14. The method of claim 12, wherein the voice channel is established at least in part by a wireless operator connection server coupled to the vehicle-based receiver.

15. The method of claim 14, wherein the SMS message is transmitted from the wireless operator connection server to the vehicle-based receiver, and an ACK message from the vehicle-based receiver is received by the wireless operator connection server.

16. The method of claim 12, further comprising receiving a NACK if the circuit switched connection fails to connect with the vehicle-based receiver.

17. The method of claim 12, wherein the message channel is established at least in part by a wireless network base station coupled to the vehicle-based receiver.

18. A communication system for sending messages between a message transmission architecture and a vehicle, the method comprising:
means for transmitting a short message service (SMS) message intended for a vehicle-based receiver;
means for monitoring for an acknowledgement (ACK) message generated in response to the SMS message, the ACK message indicating receipt of the SMS message by the vehicle based receiver; and
means for initiating a circuit switched communication connection with the vehicle-based receiver if no ACK message is received within a timeout period.

19. The communication system of claim 18, further comprising means for re-transmitting the SMS message over the circuit switched communication connection.

20. The communication system of claim 18, said means for initiating comprising a digital modem configured to establish the circuit switched communication connection over a voice channel.
